(19) United States
(12) Patent Application Publication
(10) Pub. No.: US 2006/0140253 A1
(43) Pub. Date: Jun. 29, 2006

(54) Ultra-wideband transmitter and transceiver using the same

(75) Inventors: Akira Maeki, Kokubunji (JP); Ryosuke Fujiwara, Kokubunji (JP); Masaaki Shida, Hachioji (JP); Masaru Kokubo, Foster, CA (US); Takayasu Norimatsu, Hachioji (JP)

Correspondence Address: Stanley P. Fisher;Reed Smith LLP, Suite 1400, 3110 Fairview Park Drive, Falls Church, VA, 22042-4503, US

(73) Assignee: Renesas Technology Corp.

(21) Appl. No.: 11/316,729

(22) Filed: Dec. 27, 2005

(30) Foreign Application Priority Data
Dec. 28, 2004 (JP) 2004-379188

(51) Int. Cl. H04B 1/707; H04B 1/69

(52) U.S. Cl. 375/146; 375/130

(57) ABSTRACT

An ultra-wideband transmitter is provided which can reduce a leak of a local signal into a transmitted signal with a pulse train output from an antenna in UWB-IR communication. The transmitter comprises a pulse generator 0140 for generating a pulse signal having a pulse train of pulses produced intermittently according to data to be transmitted, an oscillator 0120 for producing a local signal, a frequency converter 0130 to which the pulse signal output from the pulse generator and the local signal output from the oscillator are input, and for frequency-converting the pulse signal to output a RF signal, an amplifier 0110 for amplifying the RF signal output from the frequency converter, and an antenna 0000 for emitting the RF signal output from the amplifier in the air. In a period corresponding to a pause period of the pulses produced intermittently, a leak of the local signal into the RF signal output from the antenna is reduced using a control signal 0300.

### CLAIM OF PRIORITY

The present patent application claims priority from Japanese application JP 2004-379188 filed on Dec. 28, 2004, the content of which is hereby incorporated by reference into this application.

### FIELD OF THE INVENTION

The invention relates a transmitter for an ultra-wideband communication system using a pulse train as a transmitted signal, and a transceiver using the same.

### BACKGROUND OF THE INVENTION

Ultra-wideband impulse radio (hereinafter referred to as “UWB-IR”) communication systems conduct communications using an impulse train with a very narrow pulse width. The ultra-wideband systems employ as a modulation system, for example, a binary phase shift keying (BPSK) for reversing the polarity of a pulse train according to the value of transmitted data, or a pulse position modulation (PPM) for shifting the position of a pulse over time according to the value of transmitted data.

A communication system for modulating Gaussian monocycle pulses by PPM is disclosed in Win, M. Z. et al., “Impulse Radio: How it works”, IEEE Communications Letters, January 1998, Vol. 2, No.1, pp. 10-12. There is an example of communication system in which the BPSK modulation is applied to a pulse train of transmitted data spread using a spreading code. The BPSK modulation type UWB-IR transmitter using this direct sequence is disclosed in, for example, Japanese Patent Laid-open No. 2002-335189, and Published Japanese Translations of PCT International Publication for Patent Applications No. 2003-515974. Further, the PPM modulation type UWB-IR transmitter using the direct sequence is disclosed in, for example, Published Japanese Translations of PCT International Publication for Patent Applications No. Hei 10-508725.

### SUMMARY OF THE INVENTION

In recent years, the UWB-IR communication systems have been attracted attention as a system for effective utilization of frequency sources. In the communication system employing the impulse train, unlike a signal transmission system using normal continuous waves, information communication is carried out by transmitting and receiving intermittent energy signals. Since the pulses constituting the pulse train have the very narrow pulse width, a signal spectrum in the system has a wide frequency band as compared to communication using the normal continuous waves, and thus signal energy is distributed throughout the wide band. As a result, the signal energy at each frequency is so little that the communication can be conducted without interference with other communication systems, and that the frequency band can be shared. It is admitted by Federal Communications Commission (FCC) that the ultra-wideband communication (UWB) system is used at a frequency band of 3.1 to 10.6 GHz at a very low power of −41.3 dBm/MHz. Over the world including Japan, there is a move afoot to approve this system as a low-power communication system with the wide frequency range.

Examples of the signal waveforms in the UWB-IR communication system are shown in FIG. 18. FIG. 18A illustrates an example of a UWB-IR signal waveform obtained by modulating a pulse train by the BPSK so as to reverse the polarity of the pulse train according to a value of transmitted data. FIG. 18B illustrates an example of a waveform of a UWB-IR signal having a pulse train modulated by the PPM. In the PPM, pulses are shifted over time according to a value of transmitted data.

FIG. 19 shows an example of a schematic configuration of the BPSK modulation type UWB-IR transmitter using the direct sequence. An information source (DATA) 0310 outputs information as transmitted data. A spreading code generator (CODEG) 0320 outputs a spreading code sequence, such as a pseudo-random noise (PN) sequence. At this time, the spreading code sequence is generated at a higher rate than that of the transmitted data output by the information source 0310. A multiplier (MUX) 0330 multiplies the transmitted data output from the information source 0310 by the spreading code sequence generated by the generator 0320 to spread the transmitted data, thereby providing a spread data train. A pulse generator (PP) 0340 generates a transmitted pulse train consisting of a series of pulses intermittently produced according to the spread data train output from the multiplier 0330. At this time, the polarity of each pulse constituting the pulse train is reversed depending on the value of the spread data train. The pulse train generated by the pulse generator 0340 is subjected not only to frequency conversion and amplification, but also to RF signal processing, such as band limiting, by a radio frequency (hereinafter referred to as “RF”) front end (RFFE) 0360. Then, the pulse train is transmitted from an antenna 0000. The information source 0310, the multiplier 0330, the spreading code sequence generator 0320, and the pulse generator 0340 constitute a pulse generator (PG) 0140.

FIG. 20 shows an example of a configuration of the RF front end 0360, and FIG. 21 shows waveforms of signals at respective points of FIG. 20. A transmit pulse train 0200 output by the pulse generator 0140 is frequency-converted by a mixer 0130 serving as a frequency converter, using a local signal (carrier wave signal) 0210 output from a local oscillator (OSC) 0120. A RF signal 0220 frequency-converted by and output from the mixer 0130 is power-amplified to a predetermined power by a power amplifier (PA) 0110 to be output as a UWB RF signal 0230 from the antenna. A transmit rate at this time is set by a cycle period of the pulse generated by the pulse generator 0140, and a ratio at which information bit is spread to the pulse (spreading ratio), and the like.

In the configuration described above, the local signal 0210 from the local oscillator 0120 may leak into an output of the mixer 0130, which is called “local leak”. An electric power of the leak signal disadvantageously acts as an interfering wave to other communication systems and the self system. Thus, the local leak power needs to be reduced to −41.3 dBm/MHz or less, which is specified by the FCC described above.

Reference will now be made to the principle of occurrence of “local leak” in the mixer. The mixer for performing frequency-conversion using two input signals with different frequencies converts the frequency using a nonlinear function or multiplying function of a device. Taking as an example two-port model as shown in FIG. 22, the relationship between an input and an output in a nonlinear operation is represented by the following equation (1) by series expansion:

$${V}_{OUT} = {\sum }_{n = 0}^{N} {{C}_{n} ( {V}_{IN} )}^{n} \qquad ( 1 )$$

where v_{IN} and v_{OUT} are input and output signals in the nonlinear operation mode shown in FIG. 22, respectively, and cₙ is a coefficient at n-th term of the series expansion.

The input signal V_{IN} into the mixer is represented by the sum of a baseband signal with an amplitude v_{BB} and an angular frequency ω_{BB}, and a baseband signal with an amplitude v_{LO}, and an angular frequency ω_{LO} by means of the following equation (2):
V_{IN}=V_{BB} COS(ω_{BB}t)+V_{LO} COS(ω_{LO}t) (2)
where as the mixer output v_{OUT}, a signal of a component pω_{BB}±ω_{LO} is output by the equation (1) in which p and q are integer numbers equal to or more than zero. Note that BB is an abbreviation representing the baseband, and LO is an abbreviation representing the local, as will be used below.

In the mixer for the frequency conversion, the component with P=1 and q=1 is necessary, and does not need the higher-order term, for example, n=3, of higher order. This component appears at a frequency near a desired frequency, and cannot be removed easily by a filter. Accordingly, if possible, a square-law mixer represented by n=2 is designed in a circuit design. In the square-law mixer, the term of the higher order that is equal to or more than three can be omitted in the formula (1). The mixer output v_{OUT} is represented using a fundamental component v_{fund}, a double wave component v_{square}, and a term v_{cross} formed by a sum component and a difference component of two input waves, by the following equations (3), (4), (5), and (6):

$$\begin{matrix}{V}_{OUT} = {V}_{fund} + {V}_{square} + {V}_{cross} & ( 3 ) \\ {V}_{fund} = {c}_{1} [ {V}_{BB} COS ( {ω}_{BB} t ) + {V}_{LO} COS ( {ω}_{LO} t ) ] & ( 4 ) \\ {V}_{square} = {c}_{2} [ 2 + {V}_{BB}^{2} COS ( 2 {ω}_{BB} t ) + {V}_{LO}^{2} COS ( 2 {ω}_{LO} t ) ] & ( 5 ) \\ {V}_{cross} = \frac{1}{2} {C}_{2} {V}_{BB} {V}_{LO} [ COS ( {ω}_{BB} - {ω}_{LO} ) t + COS ( {ω}_{BB} + {ω}_{LO} ) t ] & ( 6 )\end{matrix}$$

Thus, in the mixer for sending outputs by using the nonlinear operation, two input waves (BB and LO signals) are output, in principle, from the mixer when generating the desired frequency (sum component and difference component) of the mixer. As mentioned later, since the LO signal is generally driven with a large amplitude, the problem of the local leak becomes very serious especially in the system, such as the UWB, for transmitting with low power. It should be noted that the double wave component v_{square} in the equation (5) among the outputs is removed by the filter.

Now, an example of the circuit for performing such a nonlinear operation will be described with reference to FIG. 23. FIG. 23 is a circuit diagram of the mixer using one metal oxide semiconductor field effect transistor (MOSFET). M1 is the MOSFET, C and L are a capacitor and an inductor, respectively, C_{B} is a capacitor for a DC block, R_{BIAS} is a bias resistor, V_{BIAS} and I_{BIAS} are a power source and a current source, respectively, and V_{BB}, V_{LO}, and V_{RF} are a BB signal, a LO signal, and a RF signal, respectively.

A drain current i_{D} is represented using a gate width W, a gate length L, a threshold voltage V_{T}, a magnetic permeability μ, a gate oxide film capacitor per unit area C_{OX}, and a voltage V_{gs} between a gate and a source by the following formula (7), which are device properties of the transistor M1.

$${i}_{D} = \frac{μ {C}_{OX} W}{2 L} {( {V}_{gs} - {V}_{T} )}^{2} \qquad ( 7 )$$

The gate-source voltage V_{gs} is composed of an alternate-current BB signal, an alternate-current LO signal, and a direct-current bias. Thus, the equation (7) can be represented by the following equation (8).

$${i}_{D} = \frac{μ {C}_{OX} W}{2 L} {\{ {V}_{BIAS} + [ {V}_{BB} COS ( {ω}_{BB} t ) - {V}_{LO} COS ( {ω}_{LO} t ) ] - {V}_{t} \}}^{2} \qquad ( 8 )$$

The equation (8) shows that when using the MOSFET, not only the desired frequency component, but also the LO component is output.

When using a bipolar transistor as the non-linear element, the same result will be obtained. In the bipolar transistor, a collector current i_{C} is represented using a saturation current I_{S}, a threshold voltage V_{T}, and a voltage V_{BB} between a base and an emitter V_{BB} by the following equation (9):
i_{c}≈Iₛe^{v}^{_{BE}}^{/V}^{_{T}} (9)

The equation (9) is expanded by Taylor's expansion to provide the following equation (10):

$${i}_{c} \approx {I}_{S} [ 1 + \frac{{V}_{IN}}{{V}_{T}} + {\frac{1}{2} [ \frac{{V}_{IN}}{{V}_{T}} ]}^{2} ] \qquad ( 10 )$$

At this time, the input signal v_{IN} contains the BB signal, the LO signal, and the bias component, while the LO signal is output, as is the case with the MOSFET.

The above-mentioned configuration is a single balance mixer, which may cause the problem of occurrence of the local leak in principle. Thus, circuits having a double balance mixer have been widely used so as to reduce the LO leak. It should be noted that the double balance mixer has the size of circuit twice as large as that of the single mixer, leading to a complicated configuration of the circuit, and resulting in high consuming power and large circuit size.

The operation of the double balance mixer will be described below using a Gilbert cell mixer as shown in FIG. 24. In the Gilbert cell mixer, differential LO signals V_{LO+} and V_{LO-}, and BB signals V_{BB+} and V_{BB-}, which are carrier signals, are input, and both signals are multiplied to each other to output differential RF signals V_{RF+} and V_{RF-}. At this time, the LO signals are input with sufficiently large amplitudes, whereby the transistors M1 to M4 are driven to act as switches.

For example, FIG. 25 shows an operation performed when the amplitude of the LO signal is positive. At this time, the transistors M1 and M4 are turned on to render corresponding paths conductive. In contrast, the transistors M2 and M3 are turned of f to interrupt corresponding paths of signals. The BB signal is multiplied by the LO signal to be output as the differential RF signal, while the LO signals themselves are output in the same phase respective to terminals from which the RF signals RF₊ and RF₋ are output, and are offset to zero at the RF signal outputs. Thus, since the LO signals are connected asymmetrically respective to the RF signal outputs in the double balance mixer, the LO signals are offset in principle, whereby the RF signal outputs do not include the LO signal outputs.

Now, the configuration and the principle of operation of a passive mixer will be described in detail. The passive mixer consists of a passive element (MOS switch or the like), and thus has an advantage in achieving the low consuming power. As one example of the passive type mixer, a double balance switch type NMOS mixer is shown in FIG. 26. Differential LO signals V_{LO+} and V_{LO-} are input from input terminals of the transistor switches M1 to M4. When the LO signal V_{LO+} is positive, the transistor switches M1 and M4 are brought into conduction, while the transistor switches M2 and M3 are interrupted. In this case, the RF signal V_{RF} is equal to the BB signal V_{BB} (RF signal V_{RF}=BB signal V_{BB}). In contrast, when the LO signal V_{LO-} is negative, the state is reverse to the above-mentioned case, that is, the RF signal is reverse to the BB signal V_{BB} (RF signal V_{RF}=−BB signal V_{BB}). This operation is equal to a state in which the input BB signal is multiplied by a rectangular wave with the frequency of the LO signal. Therefore, although higher harmonics of the odd-numbered order are also output, they are reduced by the filter or the like in the latter stage. As for the local leak, the LO signals are applied in the same phase to both RF output terminals, so that the LO signals are not output in principal.

As mentioned above, the problem of local leak does not occur in the double balance type structure in principal. However, even in the actual circuit with the double balance structure, the LO signal may be observed in the outputs due to variations in parameter of a nonlinear device element (for example, W/L or V_{T} in MOSFET), in a receiving element (resistance R or the like), in symmetric property caused by a layout, or in input signal, or due to noise components.

The amount of isolation of local leaks in the mixer generally used is about 20 dB to 40 dB. For example, for the local signal output of 10 dBm, the power of the local leak is −10 dBm to −30 dBm in the output from the mixer. When the power amplification is conducted in the latter stage of the mixer, the local leak power becomes larger in the antenna output stage, which may affect adversely the self or other systems. Particularly in the UWB communication, the leak power of the LO signal may result in a value exceeding the power value of −41.3 dBm as specified by the Federal Communications Commission.

FIG. 28 shows as a measurement result indicating a local leak, a spectrum provided when data is sent and received at the spreading ratio of three, at a pulse repetition frequency of 32 MHz, that is, at a transmission rate of 10.7 Mbps, using a Gaussian pulse with a band width of 2.5 nanoseconds. In the experiment, an arbitrary signal generator AWG710 manufactured by Tektronix, Inc., was used as the pulse generator 0140 in FIG. 20, a signal generator SMIQ06B manufactured by Rohde & Schwarz, Inc., as the local signal generator 0120, and a mixer DM0208LA1 manufactured by Miteq, Inc., as the mixer 0130. The isolation of the mixer 0130 is 30 dB (minimum), and 40 dB (typical), which are based on catalog descriptions. As shown in FIG. 28, the transmitted spectrum includes a signal generated due to the local leak, in addition to a UWB signal with a wide band. The measurement result shows that the local leak power is −30.8 dBm, which exceeds a tolerance specified by the Federal Communications Commission.

It is an object of the invention to provide an ultra-wideband transmitter that can reduce a leak of a local signal into a RF signal output from an antenna, and a transceiver using the same.

To solve the above-mentioned problems, in the invention, there is provided a transmitter comprising a pulse generator for generating a first signal (pulse signal) having a pulse train of pulses produced intermittently according to data to be transmitted, an oscillator for producing a second signal (local signal) which is a continuous wave, a frequency converter to which the first signal output from the pulse generator and the second signal output from the oscillator are input, and for frequency-converting the first signal to output a third signal (RF signal), an amplifier for amplifying the third signal output from the frequency converter, and an antenna for emitting the third signal output from the amplifier in the air. In a pause period of the pulses produced intermittently, a leak of the second signal into the third signal output from the antenna is reduced.

In order to decrease a leak of the second signal during the pause period of pulses intermittently produced, the transmitter preferably includes a control pulse generator for generating a fourth signal (control signal) having a pulse width including a pulse generating period of the pulses produced intermittently. Preferably, the fourth signal is used to reduce the leak of the second signal. Further, an output level of the amplified third signal is preferably decreased at the amplifier during a fourth signal's period corresponding to the pause period.

These and other objects and many of the attendant advantages of the invention will be readily appreciated as the same becomes better understood by reference to the following detailed description when considered in connection with the accompanying drawings.

### BRIEF DESCRIPTION OF THE DRAWINGS

FIG. 1 is a block diagram showing a transmitter according to a first embodiment of the invention;

FIG. 2 is a diagram showing an example of signal waveforms generated by the transmitter of FIG. 1, and of operation timing of a circuit;

FIG. 3 is a block diagram showing an example of a configuration of a pulse generator of FIG. 1, and of generation of a control signal;

FIG. 4 is a diagram showing an example of signal waveforms generated by the transmitter of FIG. 3, and of operation timing of a circuit;

FIG. 5 is another block diagram showing the first embodiment;

FIG. 6 is a block diagram showing a power amplifier used by the transmitter of FIG. 1, and a first example of an intermittent control method;

FIG. 7 is a block diagram showing an example of an input bias control circuit used by the power amplifier and the intermittent control method of FIG. 6;

FIG. 8 is a block diagram showing the power amplifier used by the transmitter of FIG. 1, and a second example of an intermittent control method;

FIG. 9 is a block diagram showing the power amplifier used by the transmitter of FIG. 1, and a third example of an intermittent control method;

FIG. 10 is a block diagram showing the power amplifier used by the transmitter of FIG. 1, and a fourth example of an intermittent control method;

FIG. 11 is a block diagram showing the power amplifier used by the transmitter of FIG. 1, and a fifth example of an intermittent control method;

FIG. 12 is a block diagram showing a second embodiment of the invention;

FIG. 13 is a block diagram showing a third embodiment of the invention;

FIG. 14 is a block diagram showing a fourth embodiment of the invention;

FIG. 15 is a block diagram showing a fifth embodiment of the invention;

FIG. 16 is a block diagram showing a sixth embodiment of the invention;

FIG. 17A is a block diagram of a transmitter according to a seventh embodiment of the invention;

FIG. 17B is another block diagram of the transmitter according to the seventh embodiment of the invention;

FIG. 18 is a diagram showing signal waveforms in ultra-wideband impulse radio communication;

FIG. 19 is a block diagram showing an example of a conventional ultra-wideband transmitter;

FIG. 20 is a block diagram of an example of a RF front end of the transmitter of FIG. 19;

FIG. 21 is a diagram showing waveforms of signals used in the transmitter of FIG. 20;

FIG. 22 is a diagram showing a two-port nonlinear model;

FIG. 23 is a circuit diagram explaining an operation of a MOSFET mixer;

FIG. 24 is a circuit diagram showing a Gilbert Cell mixer;

FIG. 25 is a diagram explaining an operation of the Gilbert Cell mixer;

FIG. 26 is a circuit diagram of a switch type NMOS double balance mixer;

FIG. 27 is a diagram explaining an operation of the switch type NMOS double balance mixer; and

FIG. 28 is a diagram showing a phenomenon of a local leak occurring when using the conventional ultra-wideband transmitter.

### DETAILED DESCRIPTION OF THE PREFERRED EMBODIMENTS

Reference will now be made in detail to a transmitter according to exemplary embodiments of the invention, which are illustrated in the accompanying drawings. Whenever possible, the same reference numbers will be used throughout the drawings for explanation to refer to the same or like parts.

### First Embodiment

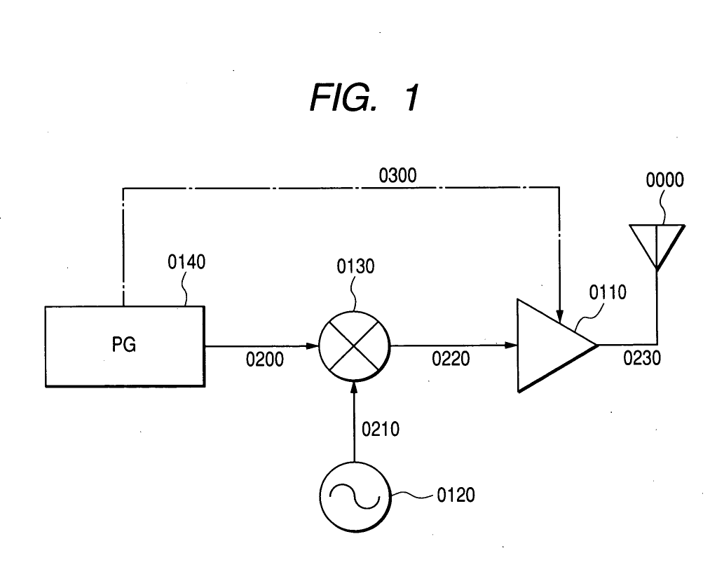

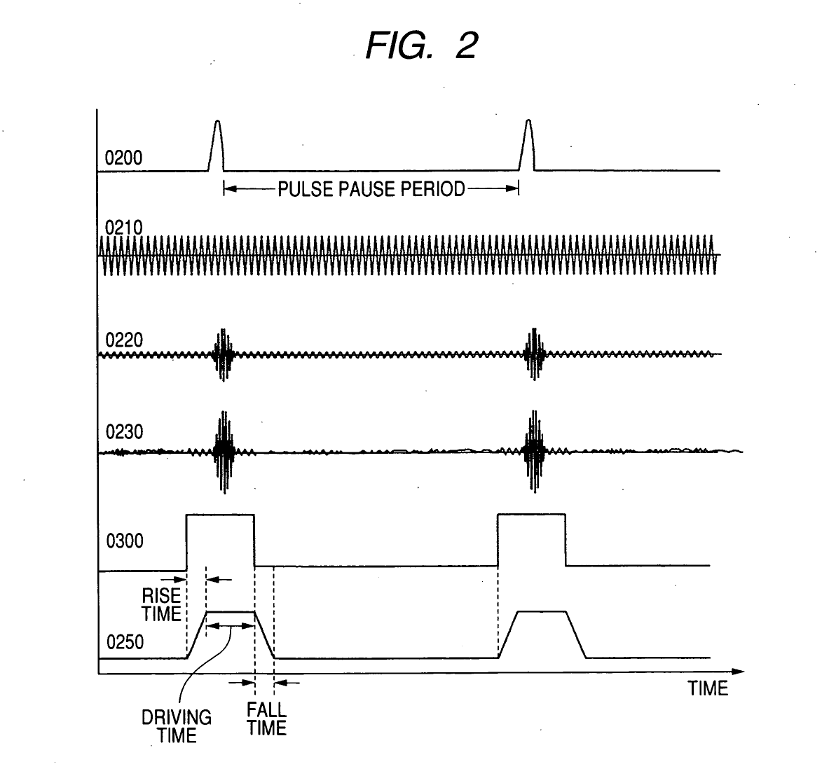

FIG. 1 illustrates a first preferred embodiment of the invention. As shown in FIG. 1, a transmitter includes an antenna 0000, a power amplifier (amplifier) 0110, a local oscillator (oscillator) 0120, a mixer (frequency converter) 0130, and a pulse generator (PG) 0140. FIG. 2 illustrates an example of signal waveforms generated by the transmitter of FIG. 1, and of operation timing of a circuit. A transmitted pulse train (first signal) 0200 generated by the pulse generator 0140 with a constant pulse cycle period is frequency-converted by the mixer 0130 using a local signal (carrier wave signal) 0210 output from the local oscillator 0120. The output signal (third signal) 0220 of the mixer 0130 is amplified by the power amplifier 0110, and then is fed to the antenna 0000 as a UWB RF signal (third signal) 0230.

The pulse generator 0140 outputs the transmitted pulse train 0200, while outputting a control signal (fourth signal) with the same cycle as that of the pulse of the transmitted pulse train 0200 to control an operation of the power amplifier 0110. The signal waveform of the power amplifier 0110 rises in the same cycle as that of the control signal 0300 with respect to input of the control signal 0300, and then is driven as shown in the operation 0250. Subsequently, the signal waveform of the amplifier falls to be terminated or decreased to have less functionality. Such a cycle is repeated. Further, as shown in FIG. 2, the transmitted pulse train 0200 has a pulse pause period where no pulse is generated, that is, a time during which no pulse is output.

The control signal 0300 is a signal for controlling a driving time of the power amplifier 0110. The control signal 0300 interrupts and decreases the outputs of the power amplifier 0110 by previously adjusting the timing of input of the transmitted pulse train 0200 into the power amplifier 0110, thereby preventing the local leak (a leak of the local signal) in the antenna 0000 at the time of non-output pulse. The above-mentioned timing adjustment involves adjusting time, including a transmission delay time of the signal, a rise time of a circuit, and a fall time thereof. For example, as shown in FIG. 2, the control signals for compensating for a variation in amplifying timing, such as the rise time of the power amplifier 0110, or the transmission delay time, are generated to compensate for the difference between the input timing of the pulse into the power amplifier 0110 and the amplifying timing of the power amplifier 0110.

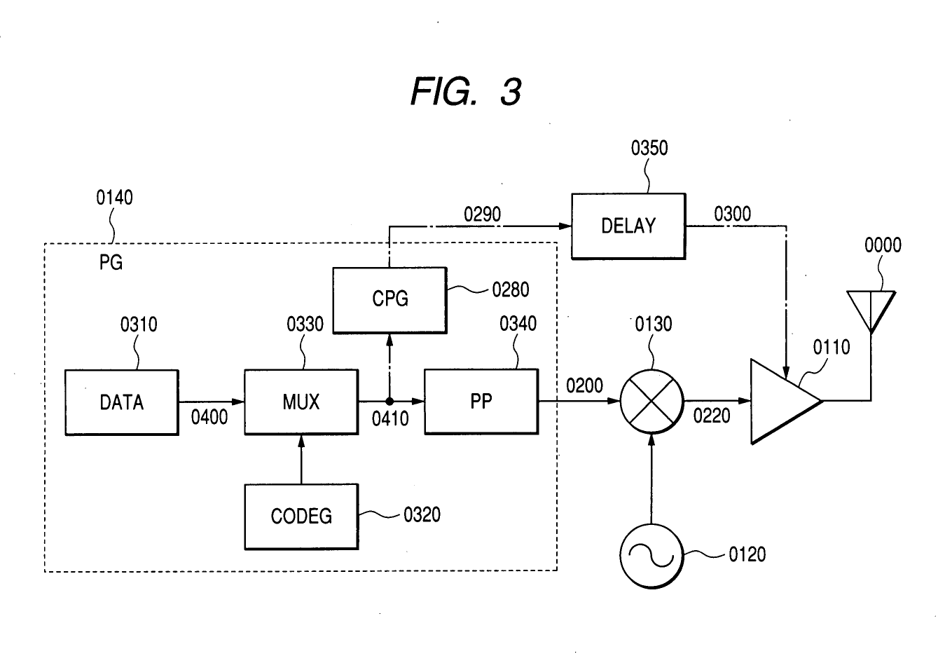

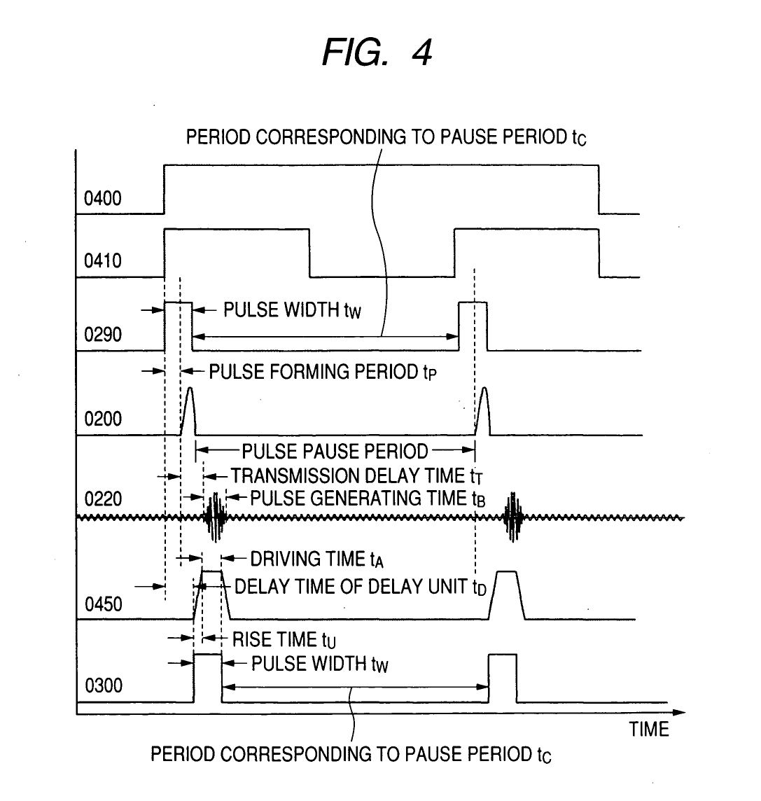

FIG. 3 shows a schematic diagram of an example of a UWB-IR transmitter including a circuit embodying the pulse generator 0140 of FIG. 1, and an example of generation of the control signal 0300. FIG. 4 illustrates signal waveforms generated in the circuit shown in FIG. 3, and an operation timing of the circuit. Note that in pulse position modulation, the control signal is generated in phase with the pulse train, thereby providing an effect of decreasing the local leak under the same control as mentioned above. Referring to FIG. 3, the circuit includes an information source (DATA) 0310, a spreading code generator (CODEG) 0320, a multiplier (MUX) 0330, a pulse generator (PP) 0340, a control pulse generator (CPG) 0280, and a delay device (DELAY) 0350. FIG. 4 illustrates transmitted data output from the information source 0310, a spread data train 0410, a control signal 0290 input into the delay device 0350, a control signal 0300 output from the delay device 0350, a transmitted pulse train 0200 output from the pulse generator 0340, an output signal (RF signal) 0220 output from the mixer 0130, and an operation 0450 of the power amplifier 0110.

The information source 0310 outputs information as the transmitted data 0400. The spreading code generator 0320 outputs a spreading code sequence, such as a pseudo-random noise (PN) sequence. At this time, the spreading code sequence is generated at a rate higher than a rate at which the transmitted data 0400 is generated by the information source 0310. The multiplier (MUX) 0330 multiplies the transmitted data 0400 output from the information source 0310 by the spreading code sequence generated by the generator 0320 to directly spread the transmitted data, thereby providing a spread data train 0410. FIG. 4 illustrates signal waveforms at the spreading ratio of two. The pulse generator 0340 generates the transmitted pulse train 0200 according to the spread data train 0410, which is an output from the multiplier 0330. The control pulse generator 0280 generates the control signal 0290 with a pulse width t_{W}, which is triggered by the rising edge of the spread data train 0410. The pulse train 0200 generated by the pulse generator 0340 is frequency-converted into a RF signal 0220 with a desired frequency by the mixer 0130, which is then power-amplified by the power amplifier 0110 to be emitted from the antenna 0000.

To achieve an intermittent operation of the power amplifier 0110 of interest, the following are taken into consideration: a time during which the spreading data string 0410 as an output signal of the amplifier 0330 is output from the pulse generator 0340 (pulse forming time tₚ), a time between output of the transmitted pulse train 0200 from the pulse generator 0340 and input of the pulse train into the power amplifier 0110 (transmission delay time t_{T}), and a rise time t_{U} required to stabilize an operation of the power amplifier 0110. The delay device 0350 is provided between the multiplier 0330 and the power amplifier 0110 to obtain a delay time t_{D} of t_{P}+t_{T}−t_{U}(t_{D}=t_{P}+t_{T}−t_{U}). A pulse generating period t_{B} of the output signal 0220 from the mixer 0130, and a driving time t_{A} of the power amplifier 0110 satisfy the following relationship: t_{B}=t_{A}. Further, the pulse width t_{W} of the control pulse 0290 and the intermittent control pulse 0300 is set to satisfy the following relationship: t_{W}=t_{A}+t_{U}. Thus, when the output signal 0220 from the mixer 0130 is input into the power amplifier 0110, the control signal 0300 is generated to stabilize the operation of the power amplifier 0110. This causes the power amplifier 0110 to operate in a period corresponding to the pulse width t_{W} of the control signal 0300, and to stop its operation or to have less functionality of amplification in a period measured by subtracting the pulse width t_{W} from the pulse cycle period, that is, in a period t_{c} corresponding to the pulse pause period (non-output pulse time). This decreases or interrupts the local leak into the transmitted signal 0230. At this time, by sufficiently increasing the driving time t_{A} of the power amplifier 0110, the accuracy required for the timing adjustment can be reduced, or the necessity of modification by the delay device 0350 can be eliminated. In contrast, the local leak power into the antenna 0000 is increased. It should be noted that the delay device 0350 may be achieved by employing a delay element, and/or a cable, or adjusting the length of a signal line. These components may be installed in various arrangements as needed.

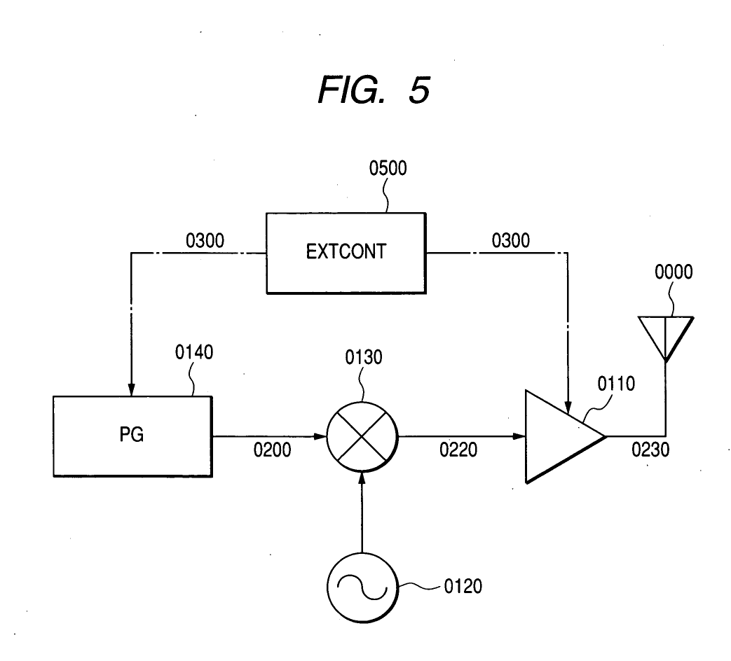

FIG. 5 shows an example of a configuration of another circuit for generating the control signal 0300. In this configuration, an intermittent operation is achieved using an external controller (EXTCONT) 0500 for generating pulses. The external controller 0500 generates and outputs the control signal 0300 with the predetermined pulse cycle period. The control signal 0300 is input into the pulse generator 0140 and the power amplifier 0110.

The pulse generator 0140 generates the spread data train 0410 and the transmitted data string 0200, which are triggered by the pulse rising edge of the control signal 0300. As to both signals supplied to the pulse generator 0140 and the power amplifier 0110, the following are considered: a pulse forming time of the pulse generator 0140 (a time between input of the control signal 300 and output of the transmitted pulse train 0200), a transmission delay time between output of the transmit pulse from the generator and input of the pulse into the power amplifier 0110, and a time between input of the control signal 0300 into the power amplifier 0110 and stabilization of the power amplifier 0110. Thus, the time position of the control signal 0300 is adjusted to the timing of power amplification by the external controller 0500 or another delay device (not shown)-installed. The control signal 300, the timing of which is adjusted, decreases or interrupts the output from the power amplifier 0110 in the period t_{C} corresponding to the non-output time of pulse. As mentioned above, the control signal 300 into the power amplifier 0110 may be used for generating the transmitted pulse train 0200, or another transmitted pulse train by modifying the transmit pulse train 0200 by the delay time.

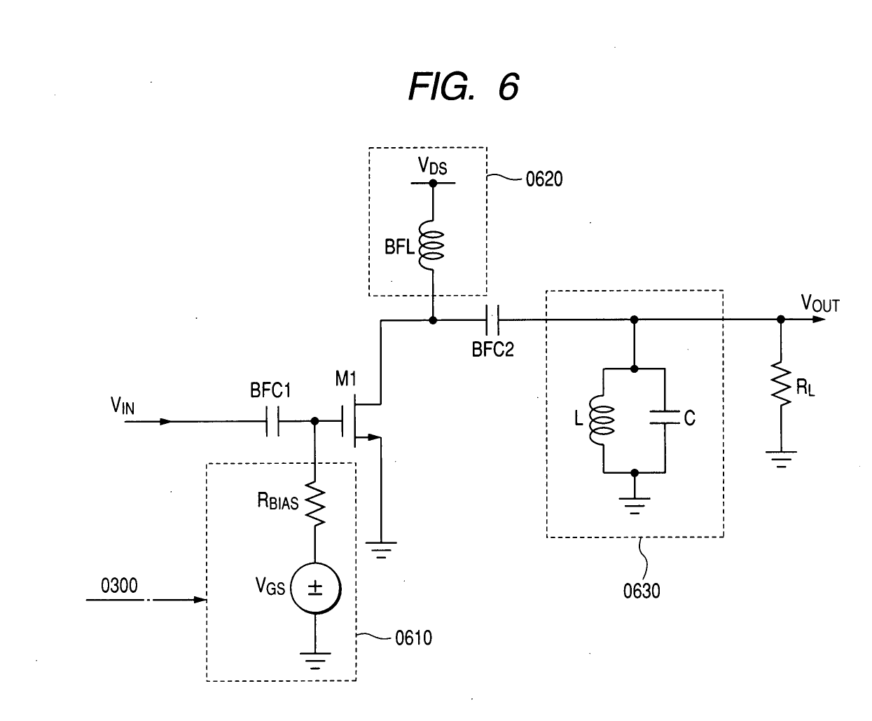

FIG. 6 illustrates an example of a first configuration embodying the power amplifier 0110 shown in FIG. 1. The power amplifier 0110 decreases or interrupts the outputs by use of the control signal 0300. In FIG. 6, v_{IN} is an input signal into the power amplifier 0110 of FIG. 1, v_{OUT} is an output signal from the power amplifier 0110 , V_{GS} and V_{DS} are a gate-source bias voltage, and a drain-source bias voltage, respectively, M1 is a MOSFET, BFC1 and BFC2 are DC cut capacitors, BFL is a choke coil, L and C are an inductor and a capacitor for a matching circuit, respectively, R_{BIAS} is a bias resistor, and R_{L} is an output resistor. In the figure, an input bias control circuit is indicated at 0610, an output bias control circuit at 0620, and an output matching circuit at 0630.

The transistor M1 amplifies the input signal V_{IN}, which is an output signal 0220 from the mixer 0130, to output the output signal v_{OUT} which is a RF UWB signal 0230 output via the output matching circuit 0630, where the operation of the transistor M1 is controlled by a bias voltage given by an output bias control circuit 0620.

FIG. 7 illustrates an example of a configuration embodying the bias control circuit 0610 shown in FIG. 6. The bia control circuit 0610 is provided with a switch 0700, into which the control signal 0300 is input. The switch 0700 selects a bias voltage V_{GS} in a period during which the control signal 0300 is input (pulse width t_{W}), while selecting a ground in a period during which no input signal exists (in a period other than the pulse width t_{W}). When the ground is selected, the input bias voltage is interrupted, and an operation of amplification of the transistor M1 is interrupted. This can achieve reduction of leaks of interest.

The operation of the bias control circuit 0610 is for controlling the bias voltage of the transistor M1, and thus is achieved by adjustment of the gate-source bias voltage V_{GS}, or by adjustment of a resistance of the bias resistor R_{BIAS} by switching a variable resistor, or a resistor employing a switch or the like.

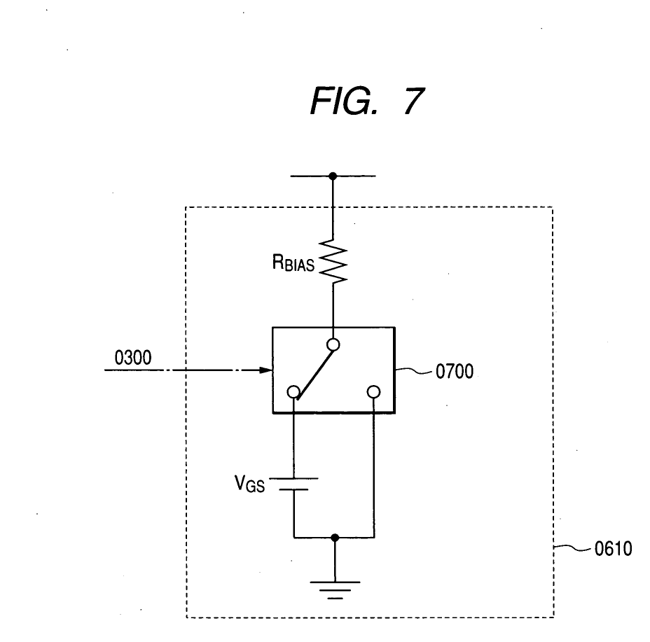

FIG. 8 illustrates an example of a second configuration embodying the power amplifier 0110 of FIG. 1. The configuration includes a variable resistor R_{VAR} connected in parallel to a choke coil BFL of the output side bias control circuit 0620, in addition to the configuration of FIG. 6. A signal 0300* into which the control signal 0300 is reversed is input into the output side bias control circuit 0620, where the resistance of the variable resistor R_{VAR} is controlled by the signal 0300*. The resistance of the variable resistor R_{VAR} is decreased in a period during which no input signal into the power amplifier 0110 exists, thereby reducing unwanted radiations caused due to the intermittent operation of the power amplifier 0110.

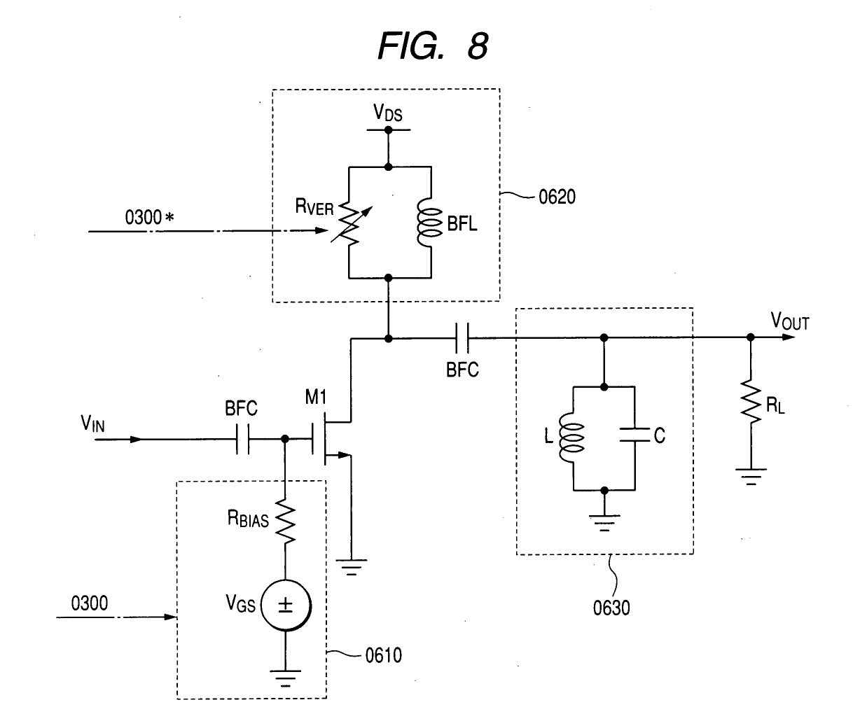

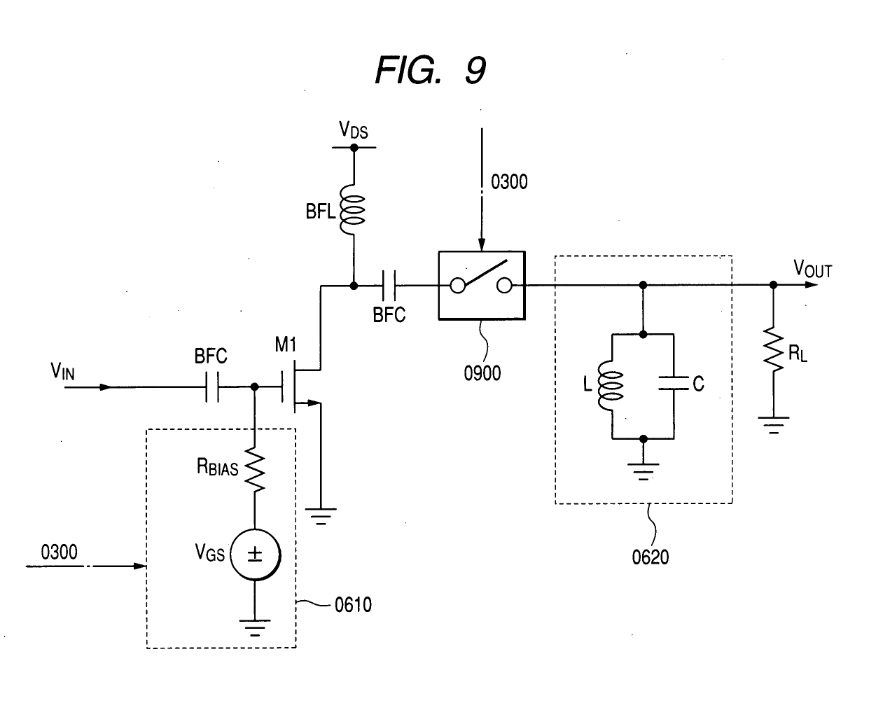

FIG. 9 illustrates an example of a third configuration embodying the power amplifier 0110 of FIG. 1. The configuration includes a switch 0900 for connecting or disconnecting the line on its output side, in addition to the configuration of FIG. 6. The control signal 0300 is used as a control signal into the switch 0900. While no signal is input into the power amplifier 0110, the switch 0900 disconnects the line on the output side, and reduces the unwanted radiations caused due to the intermittent operation of the power amplifier 0110.

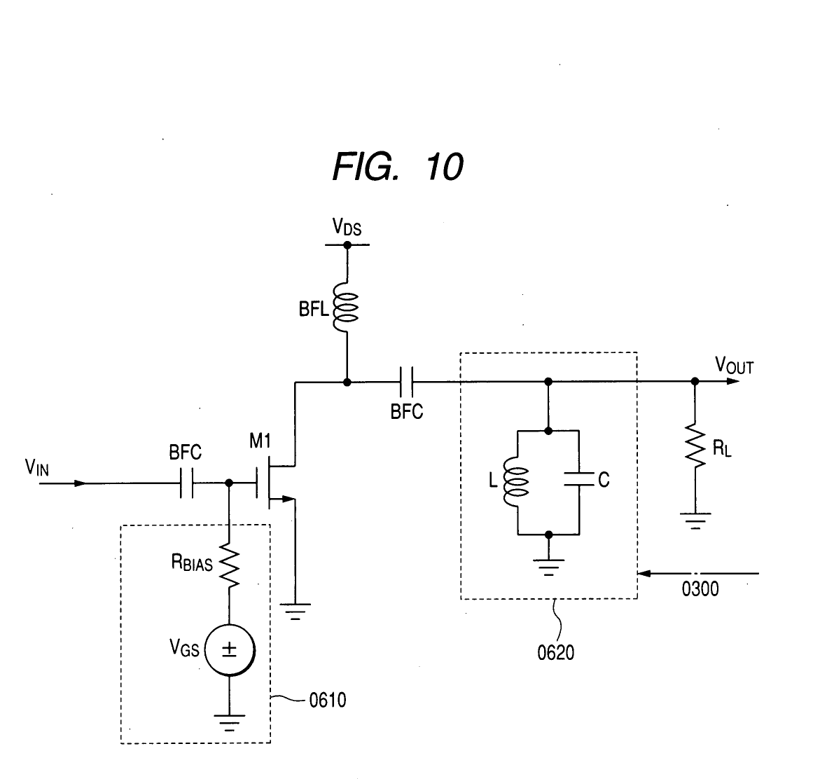

FIG. 10 illustrates an example of a fourth configuration embodying the power amplifier 0110 of FIG. 1. The control signal 0300 is input to the output matching circuit 0620, so that at least one of an inductor L and a capacitor C of the output matching circuit 0620 is varied by the control signal 0300. The bias voltage V_{GS} applied between the gate and the source is not changed to be constant. The output matching circuit 0620 is in a matching state when any signal is input to the power amplifier 0110. In contrast, when no signal is input to the amplifier, either or both of the inductor L and capacitor C may be changed, causing the matching circuit to be in a mismatching state, so that the outputs from the power amplifier 0110 is decreased or interrupted. Although not shown in FIG. 10, in a case where a matching circuit is provided on an input side of the power amplifier 0110, the matching circuit is switched between the matching state and the mismatching state by the control signal 0300, as is the case with on the output side thereof, so that the output from the power amplifier 0110 can be decreased or interrupted while no signal is input.

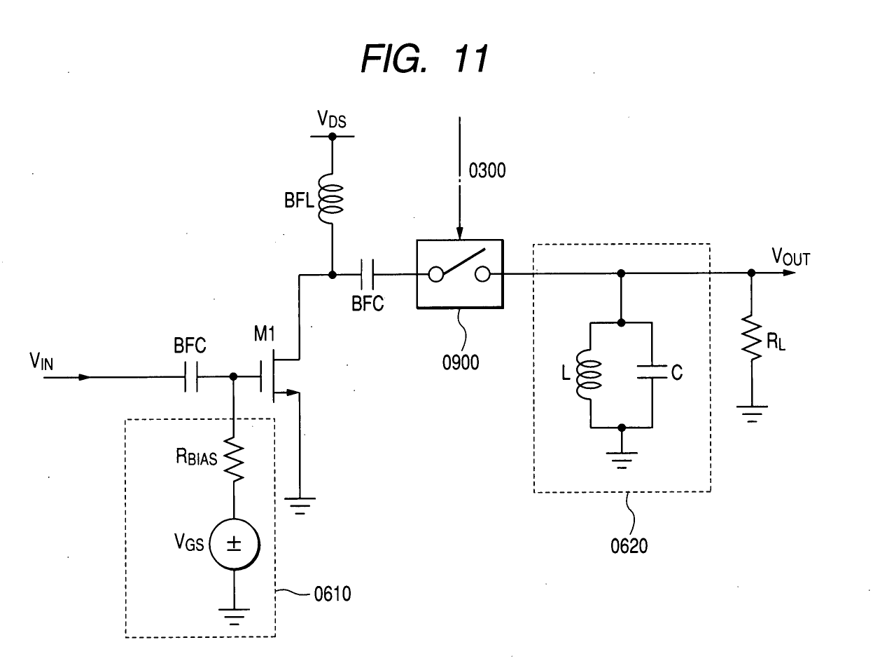

FIG. 11 illustrates an example of a fifth configuration embodying the power amplifier 0110 of FIG. 1. On the output side, there is provided a switch 0900 for disconnecting the connection. The control signal 0300 is used as a control signal for the switch 0900. A gate-source bias voltage V_{GS} is not changed, and remains constant. While no signal is input to the power amplifier 0110, the switch 0900 disconnects the line on the output side, and the output from the power amplifier 0110 is interrupted. The switch 0900 may be provided in the later stage of the output matching circuit 0620. While no input signal exists in the amplifier, the output from the power amplifier 0110 can be interrupted. Further, the switch 0900 can be disposed on the input side of the power amplifier 0110. While no input signal into the amplifier 0110 exists, the switch 0900 disconnects the line on the input side, thereby interrupting the outputs from the amplifier 0110.

In the above-mentioned configuration of the embodiment, the power of the power amplifier 0110 is interrupted during the period t_{C} corresponding to the time of non-output pulse. This configuration has an advantage in that the unwanted power consumption at the power amplifier 0110 can be reduced.

### Second Embodiment

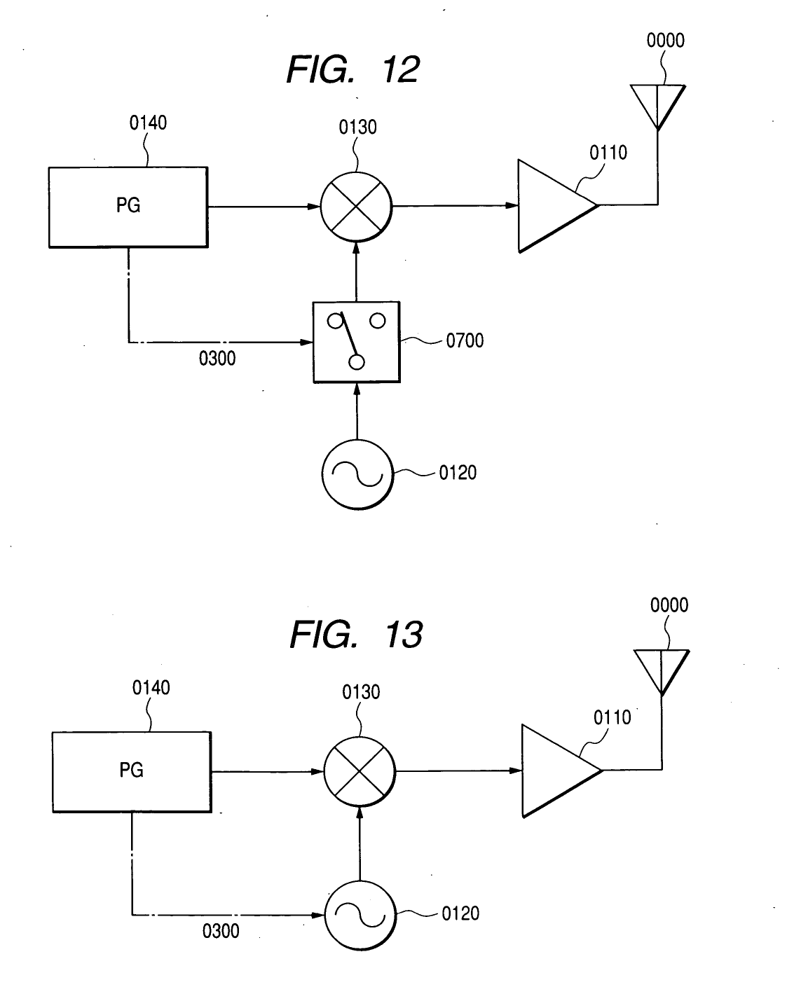

FIG. 12 illustrates a second preferred embodiment of the invention. In the embodiment, a switch 0700 is disposed between the mixer 0130 and the local oscillator 0120. The control signal 0300 output from the pulse generator is input to the switch 0700, where the LO signal output from the local oscillator 0120 is transmitted to the mixer 0130 in outputting the pulse from the pulse generator 0140, so that the mixer 0130 frequency-converts the pulse output from the pulse generator 0140 into a RF signal. During the period t_{C} corresponding to the time of non-output pulse, the switch 0700 is turned off, thereby stopping supplying of the output signal of the local oscillator 0120 into the mixer 0130. This can decrease the local leak at the antenna. Since in the configuration, the power supply to the circuit is not interrupted, the consumed power is not decreased, but a stable operation of the transmitter is expected. Switching of the switch 0700 can be achieved in a few nanoseconds, and thus is available even when a high-speed pulse train is transmitted.

### Third Embodiment

FIG. 13 illustrates a third preferred embodiment of the invention. In the embodiment, the control signal 0300 output from the pulse generator 0140 is input to the local oscillator 0120, which changes the LO output signal by the control signal 0300. When outputting the pulse of the control signal 0300, the LO signal is output from the local oscillator 0120 at a desired frequency and output. During the period t_{C} corresponding to the non-output pulse time, the LO signal is decreased or interrupted. This can decrease the local leak at the antenna. A method for interrupting the LO signal includes a power interruption of the local oscillator 0120 or the like. Note that the local oscillator 0120 is a circuit for oscillating a predetermined RF signal, such as a PLL (Phase Locked Loop), or a VCO (Voltage Controlled Oscillator).

### Fourth Embodiment

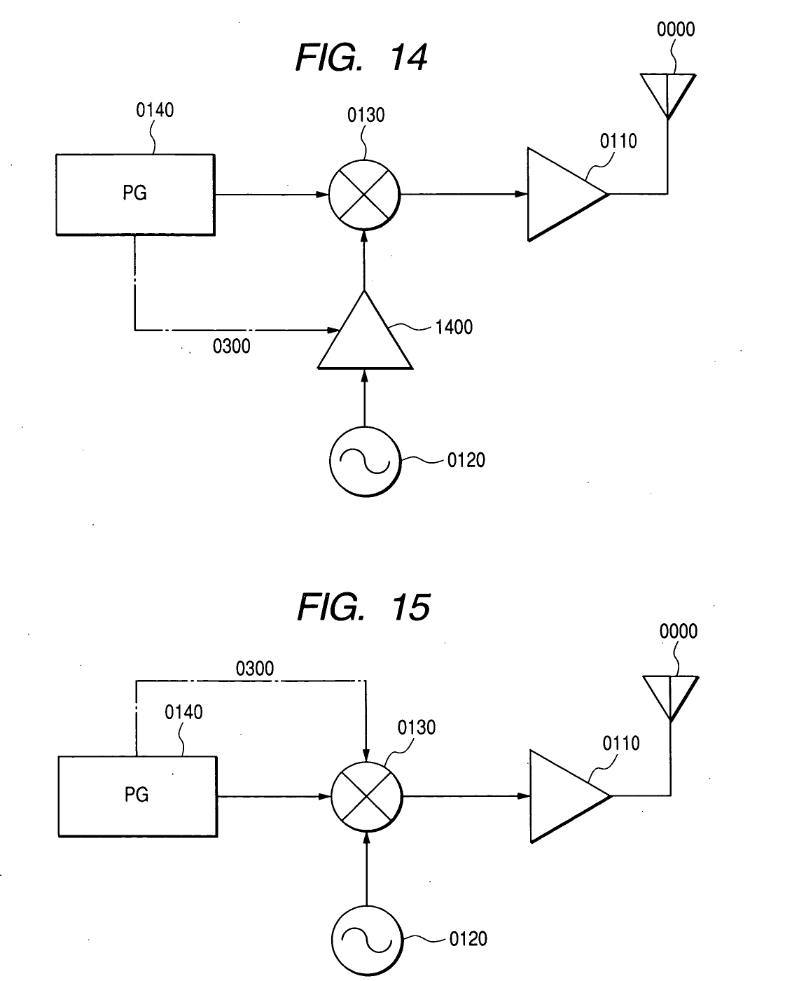

FIG. 14 illustrates a fourth preferred embodiment of the invention. In the embodiment, a buffer amp (buffer amplifier) 1400 is disposed between the mixer 0130 and the local oscillator 0120. The buffer amp 1400 absorbs variations in output impedance of the local oscillator 0120. To the buffer amp 1400, the control signal 0300 output from the pulse generator 0140 is given. During the period t_{C} corresponding to the non-output pulse time of the control signal 0300, the buffer amp 1400 is in an open state due to the power interruption or the like. Thus, the output from the local oscillator 0120 is interrupted, thereby decreasing the local leak at the antenna 0000.

### Fifth Embodiment

FIG. 15 illustrates a fifth preferred embodiment of the invention. In the embodiment, the control signal 0300 output from the pulse generator 0140 is input to the mixer 0130. During the period t_{C} corresponding to the non-output pulse time of the control signal 0300, a gain of the mixer 0130 is decreased, or the operation of the mixer is stopped. This can decrease the local leak at the antenna.

### Sixth Embodiment

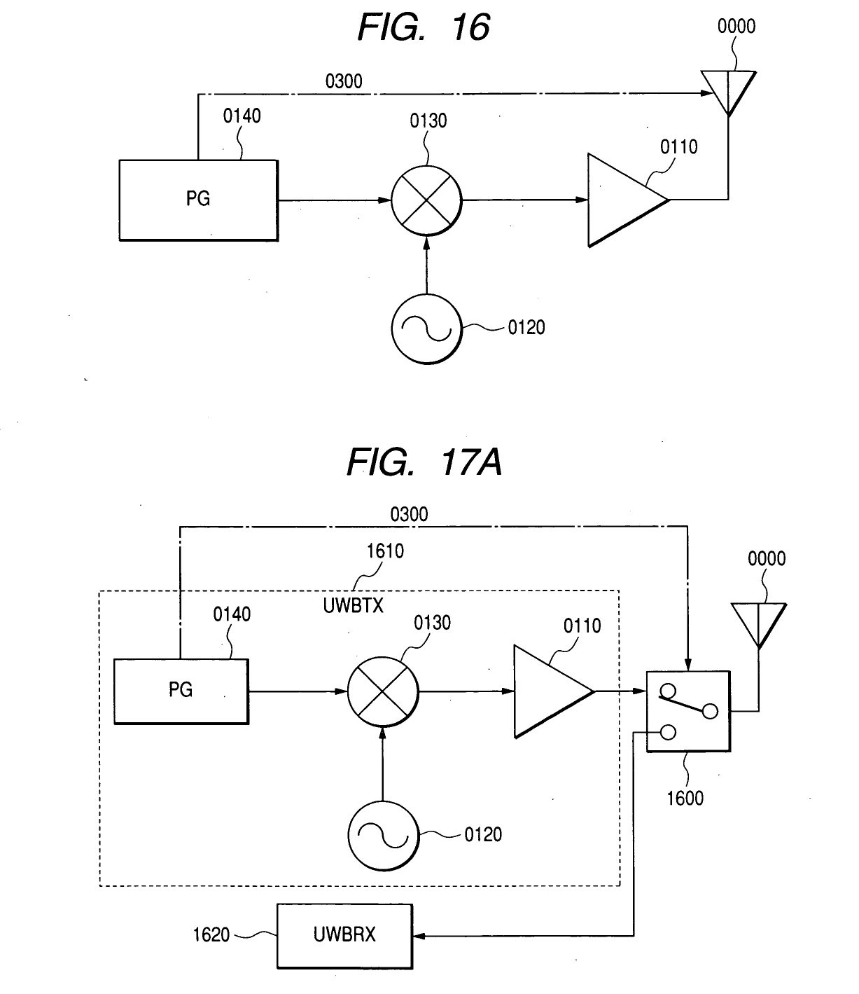

FIG. 16 illustrates a sixth preferred embodiment of the invention. In the embodiment, the control signal 0300 output from the pulse generator 0140 is input to the antenna 0000. Although not shown in the figure, the antenna 0000 has a matching circuit. During the period t_{C} corresponding to the non-output pulse time of the control signal 0300, a matching condition of the matching circuit is adjusted, or connection is opened, which can decrease the local leak.

### Seventh Embodiment

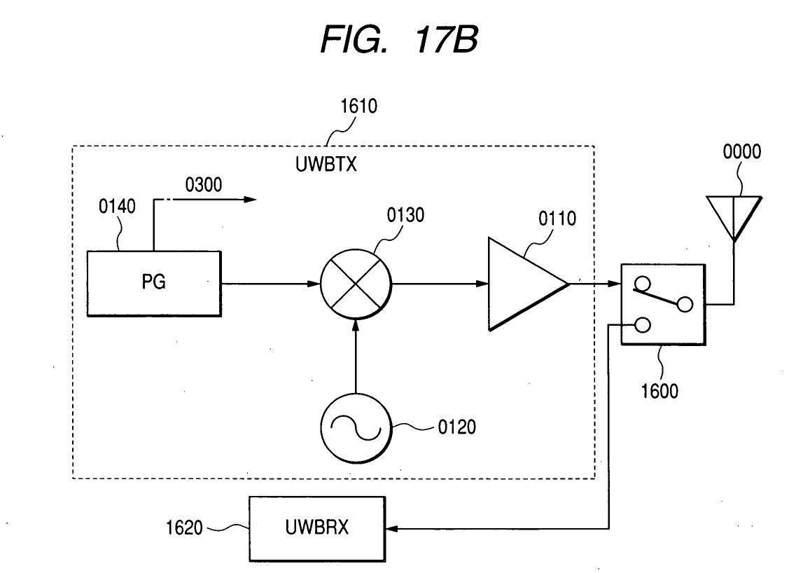

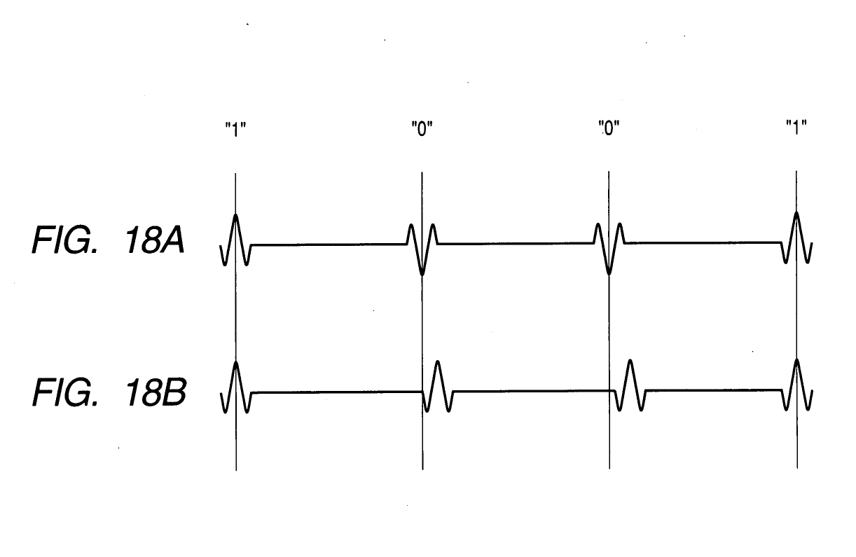

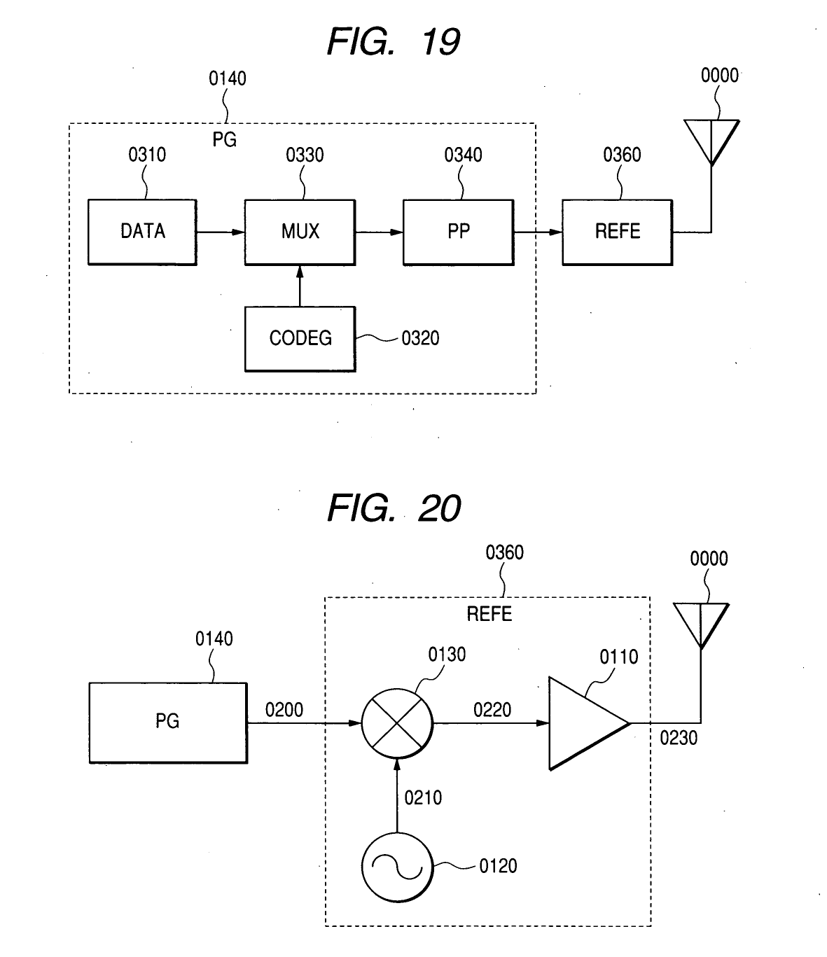

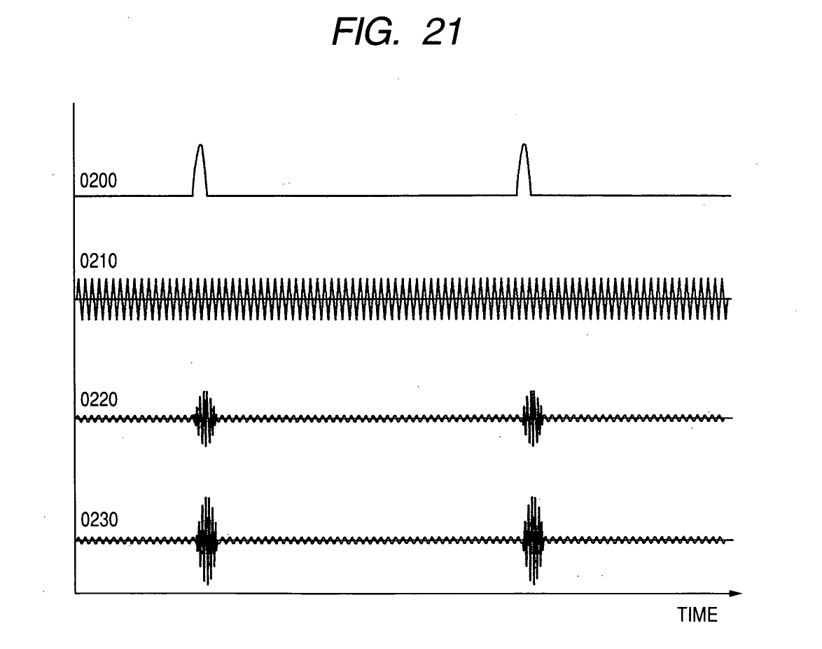

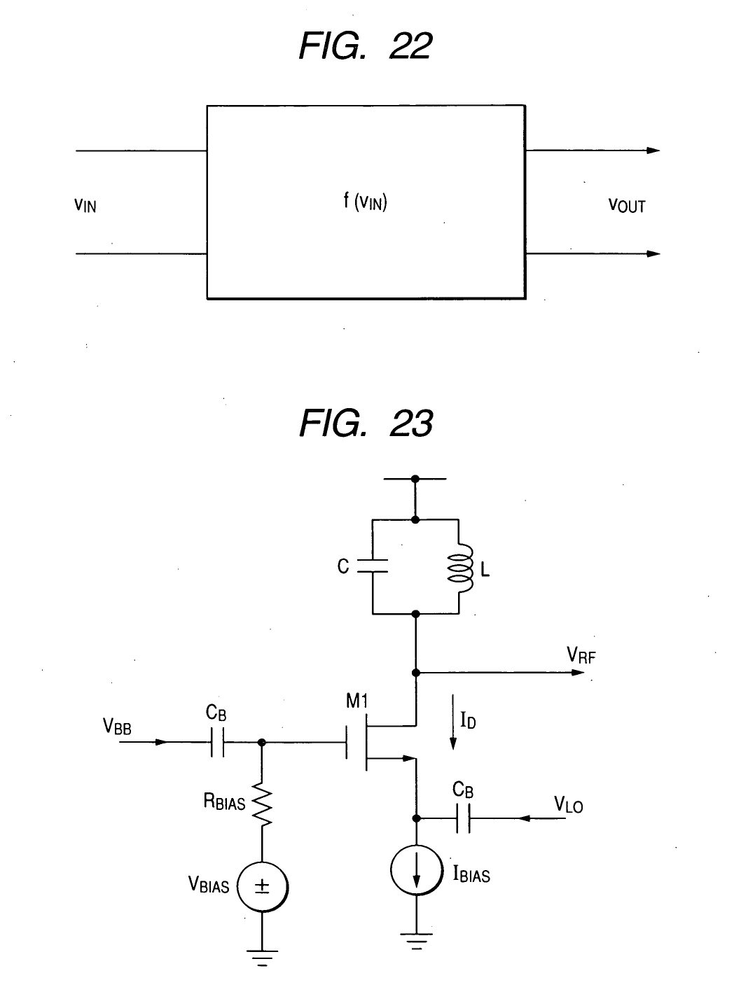

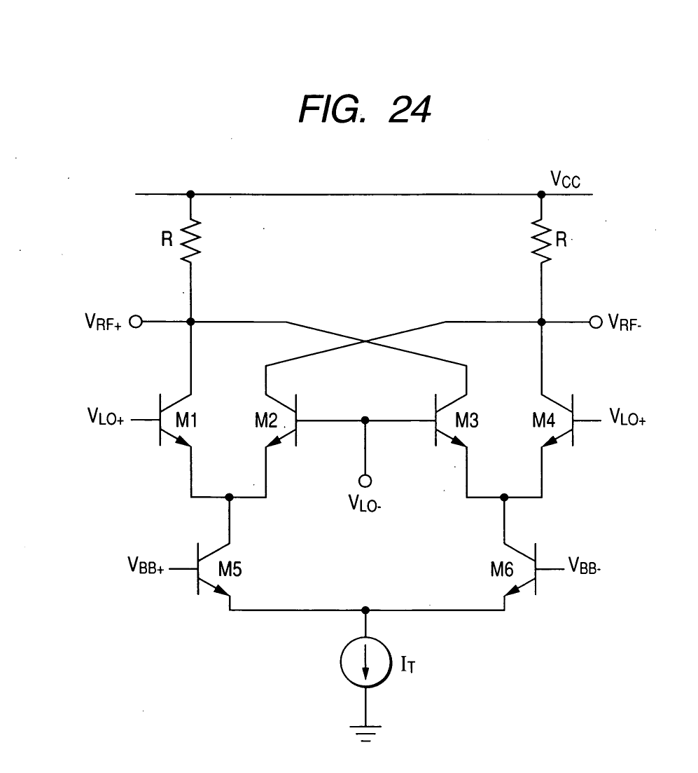

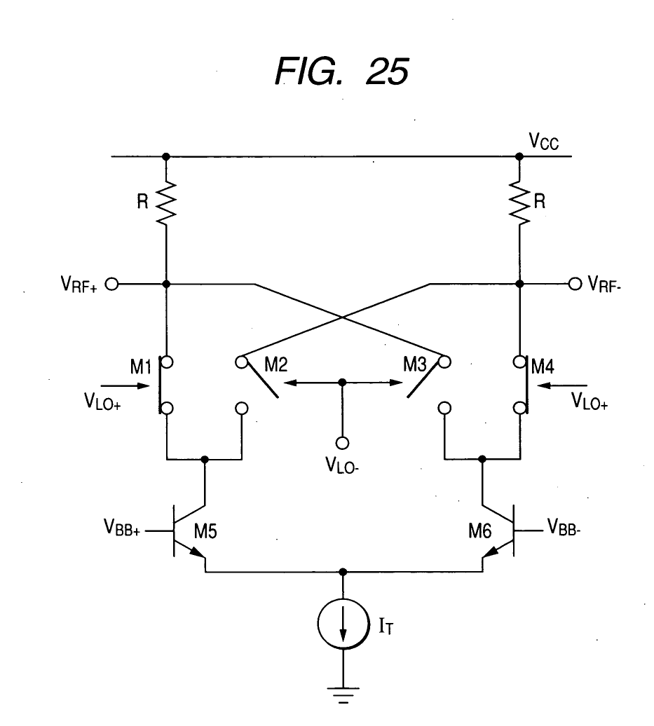

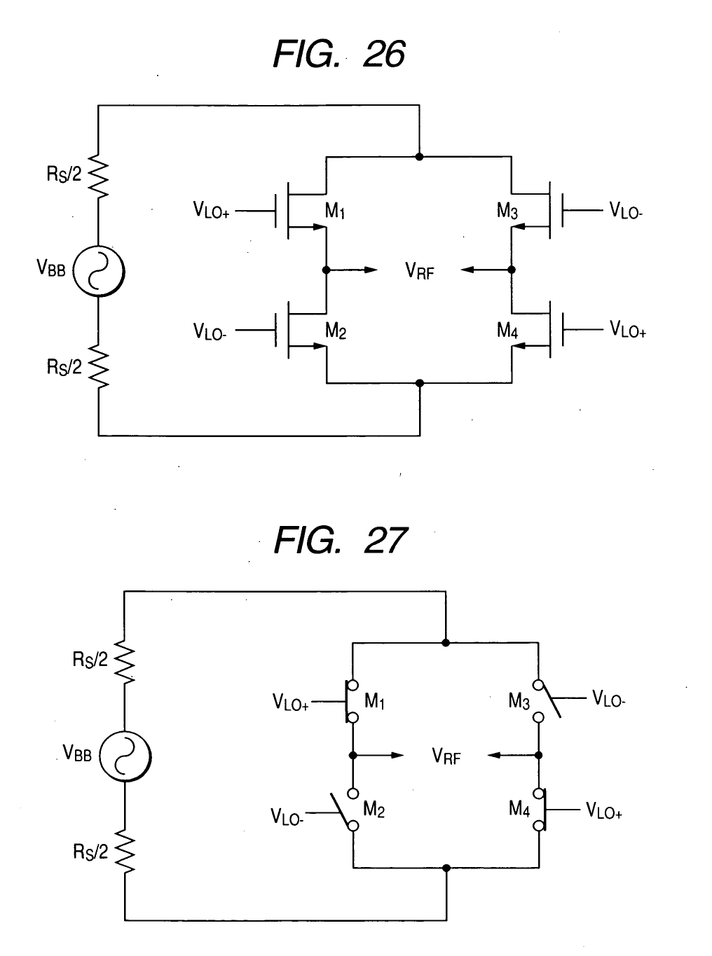

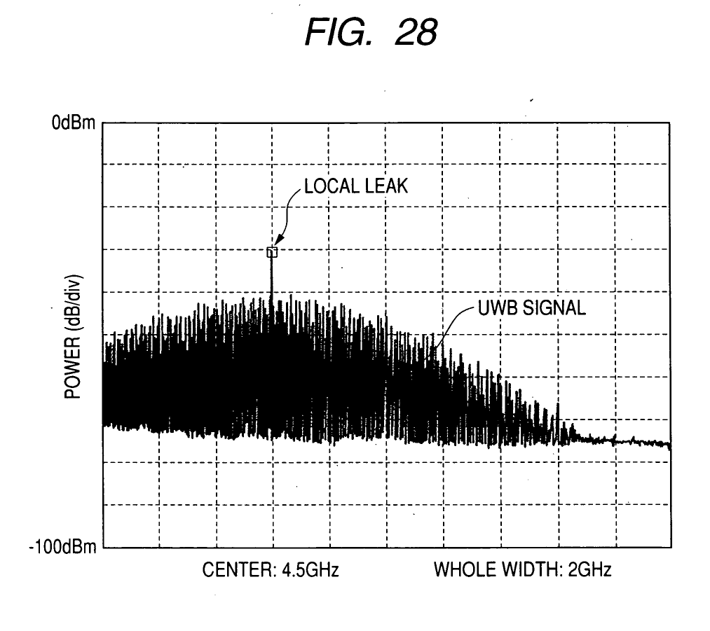

FIG. 17A shows a transceiver according to a seventh preferred embodiment of the invention. More specifically, FIG. 17A illustrates a transmit-receive changeover switch 1600 disposed between the power amplifier 0110 and the antenna 0000 for switching connections by transmitting and receiving, a UWB transmitter circuit 1610 including the power amplifier 0110, the local oscillator 0120, the mixer 0130, and the pulse generator 0140, and a UWB receiving circuit 1620. The UWB transmitter circuit 1610 outputs a RF signal (first signal) 0230 from transmitted data input. The UWB receiving circuit 1620 allows for input of a RF signal (fourth signal) received by the antenna 0000, and outputs received data. The transceiver of the embodiment includes the UWB transmitter circuit 1610, the transmit-receive changeover switch 1600, the antenna 0000, and the UWB receiving circuit 1620.

The control signal (fifth signal) 0300 output from the pulse generator 0140 is input into the transmit-receive changeover switch 1600. Within the pulse width t_{W} of the control signal 0300, the antenna 0000 is connected to the UWB transmitter circuit 1610, while during the period t_{C} corresponding to the time of non-output pulse of the control signal 0300, the antenna 0000 is connected to the UWB receiver 1620. This can decrease the local leak at the antenna 0000.

As shown in FIG. 17B, the UWB transmitter circuit 1610 may include the power amplifier 0110, the local oscillator 0120, the mixer 0130, and the pulse generator 0140 in the transmitter of the first to fifth embodiments. The transmit-receive changeover switch 1600 may be driven according to another transmit/receive switching timing, not based on the control signal 0300. The control signal 0300 is used within the UWB transmitter circuit 1610. During the period t_{C} corresponding to the non-output pulse time of the control signal 0300, the local leak can be decreased at the antenna 0000.

The above-mentioned first to seventh embodiments may be combined for use, thereby maximizing a desired amount of reducing the local leak. In any one of the first to seventh embodiments, a filter for limiting a band of a RF UWB signal 0230 can be disposed between the power amplifier 0110 and the antenna 0000 as needed. Although, in the above-mentioned two embodiments, there are disclosed methods for generating the control signal 0300 in the control pulse generator 0280 and in the external controller 0550, the invention is not limited thereto. The above-mentioned methods and structures are illustrative rather than limiting of the present invention, and can be used in other embodiments. Further, the method and structure for generating the control signal 0300 is not limited to the above-mentioned two embodiments. Other methods and structures can be employed which enable the local signal output from the antenna to be decreased or interrupted at the non-output pulse time.

According to the invention, an ultra-wideband transmitter and a transceiver using the same are expected to be provided which decreases a leak of the local signal in a pause period of pulses intermittently occurring.

It is further understood by those skilled in the art that the foregoing description is a preferred embodiment of the disclosed device and that various changes and modifications may be made in the invention without departing from the spirit and scope thereof.

What is claimed is:

1. A transmitter comprising:
a pulse generator for generating a first signal arranged in a pulse train of pulses produced intermittently according to data to be transmitted;
an oscillator for producing a second signal which is a continuous wave;
a frequency converter to which the first signal output from the pulse generator and the second signal output from the oscillator are input, and for frequency-converting the first signal to output a third signal;
an amplifier for amplifying the third signal output from the frequency converter; and
an antenna for emitting the third signal output from the amplifier in the air,
wherein a leak of the second signal into the third signal output from the antenna is reduced in a pause period of the pulses produced intermittently.

2. The transmitter according to claim 1, further comprising a control pulse generator for generating a fourth signal having a pulse width including a pulse generating period of the pulses produced intermittently,
wherein the fourth signal is used to reduce the leak of the second signal into the third signal.

3. The transmitter according to claim 2, wherein a signal transmission path for the second signal from the oscillator to the antenna includes a part where the transmission of the second signal is reduced during a fourth signal's period corresponding to the pause period.

4. The transmitter according to claim 2, wherein the amplifier decreases an output level of the amplified third signal during the period corresponding to the pause period of the fourth signal.

5. The transmitter according to claim 2, wherein the frequency converter decreases an output level of the third signal during the fourth signal's period corresponding to the pause period.

6. The transmitter according to claim 2, wherein the oscillator decreases an output level of the second signal during the fourth signal's period corresponding to the pause period.

7. The transmitter according to claim 2, wherein a switch adapted to open and close by the fourth signal is connected between the frequency converter and the oscillator, and the switch is opened during the fourth signal's period corresponding to the pause period to interrupt the second carrier wave signal.

8. The transmitter according to claim 2, wherein a buffer amplifier for amplifying the second signal is connected between the frequency converter and the oscillator, and the buffer amplifier decreases the output level of the amplified second signal during the fourth signal's period corresponding to the pause period.

9. The transmitter according to claim 2, wherein the antenna includes a matching circuit, and the matching circuit decreases the output level of the third signal given to the antenna during the fourth signal's period corresponding to the pause period.

10. The transmitter according to claim 2, wherein a changeover device for switching between transmission and reception is connected between the amplifier and the antenna, and the changeover device is switched to the reception during the fourth signal's period corresponding to the pause period.

11. A transceiver comprising:
a transmitter circuit for receiving transmitted data input, and outputting a third signal;
an antenna for emitting the transmitted signal in the air, and receiving a radio wave reaching to output a fourth signal;
a receiving circuit to which the fourth signal output from the antenna is input, and for outputting received data; and
a changeover device for switching between a connection between the transmitter circuit and the antenna, and a connection between the antenna and the receiving circuit,
the transmitter circuit comprising:
a pulse generator for generating a first signal arranged in a pulse train of pulses produced intermittently according to data to be transmitted;
an oscillator for producing a second signal which is a continuous wave;
a frequency converter to which the first signal output from the pulse generator and the second signal output from the oscillator are input, and for frequency-converting the first signal to output a third signal;
an amplifier for amplifying the third signal output from the frequency converter; and
the antenna for emitting the third signal output from the amplifier in the air,
wherein a leak of the second signal into the third signal output from the antenna is reduced in a pause period of the pulses produced intermittently.

12. The transceiver according to claim 11, further comprising a control pulse generator for generating a fifth signal having a pulse width including a pulse generating period of the pulses produced intermittently,
wherein the fifth signal is used to reduce the leak of the second signal into the third signal.

13. The transceiver according to claim 12, wherein a signal transmission path for the second signal from the oscillator to the antenna includes a part where the transmission of the second signal is reduced during a fifth signal's period corresponding to the pause period.

14. The transceiver according to claim 12, wherein the amplifier decreases an output level of the amplified third signal during the of the fifth signal's period corresponding to the pause period of the fifth signal.

15. The transceiver according to claim 12, wherein the frequency converter decreases an output level of the third signal during the fifth signal's period corresponding to the pause period.

16. The transceiver according to claim 12, wherein the oscillator decreases an output level of the second signal during the fifth signal's period corresponding to the pause period.

17. The transceiver according to claim 12, wherein a switch adapted to open and close by the fifth signal is connected between the frequency converter and the oscillator, and the switch is opened during the fifth signal's period corresponding to the pause period to interrupt the second carrier wave signal.

18. The transceiver according to claim 12, wherein a buffer amplifier for amplifying the second signal is connected between the frequency converter and the oscillator, and the buffer amplifier decreases the output level of the amplified second signal during the fifth signal's period corresponding to the pause period.

19. The transceiver according to claim 12, wherein the changeover device is switched to the reception during the fifth signal's period corresponding to the pause period.
